(19) United States
(12) Patent Application Publication
(10) Pub. No.: US 2013/0093381 A1
(43) Pub. Date: Apr. 18, 2013

(54) ENERGY SAVING CABLE ASSEMBLY

(71) Applicants: James McGINLEY, Barrington, IL (US); Donald Rimdzius, Addison, IL (US)

(72) Inventors: James McGINLEY, Barrington, IL (US); Donald Rimdzius, Addison, IL (US)

(73) Assignee: VOLTSTAR TECHNOLOGIES, INC., Schaumburg, IL (US)

(21) Appl. No.: 13/397,964

(22) Filed: Feb. 16, 2012

Related U.S. Application Data
(63) Continuation-in-part of application No. 12/176,261, filed on Jul. 18, 2008, now Pat. No. 7,910,834.
Application No. 12/176,261 is a continuation-in-part of application No. 12/127,592, filed on May 27, 2008, now Pat. No. 7,910,833.
(60) Provisional application No. 61/443,611, filed on Feb. 16, 2011.
(60) Provisional application No. 61/507,306, filed on Jul. 13, 2011.

(51) Int. Cl. H02J 7/00; H02J 7/02

(52) U.S. Cl. CPC H02J 7/0068; H02J 7/02; H02J 7/0093; H02J 7/0042
USPC 320/107; 320/128; 320/134; 320/129

(57) ABSTRACT

A power charger circuit converts input energy to DC output energy, with the input energy flowing in a first direction such as via a cable having multiple conductors to provide the output energy, with the power charger including at least one switch having an open state and a closed state, the open state to interrupt the flow of input energy and the power charging circuit allowing for energy flow in a second direction opposite the first direction so that the switch may be moved to the closed state.

### CROSS-REFERENCE TO RELATED APPLICATIONS

This application is a conversion of U.S. Provisional Patent Application No. 61/443,611 filed Feb. 16, 2011, and a conversion of U.S. Provisional Patent Application. No. 61/507,306 filed Jul. 13, 2011, from both of which applications priority is claimed. This application is also a continuation-in-part of U.S. patent application Ser. No. 12/176,261 filed Jul. 18, 2008, (now U.S. Pat. No, 7,960,648) which is a continuation-in-part of U.S. patent application Ser. No. 12/127,592, filed on May 27, 2008, now U.S. Pat. No. 7,910,833) and U.S. patent application Ser. No. 13/054,643, which is the U.S. National Stage Entry of International Application PCT/US09/46223 filed on Jun. 4, 2009, which was a continuation-in-part of the aforementioned U.S. patent applications Ser. Nos. 12/176,261, 12/251,898, and 12/251,882. The entireties of all of the foregoing are hereby incorporated by reference.

### BACKGROUND

This application relates to power devices and, more particularly, to power devices having an automatic shut-off feature to reduce or eliminate unnecessary use of power when not being used to actively charge a battery operated target device.

In a conventional AC charger, power from an AC power source flows through an AC to DC converter to convert the AC voltage to a DC voltage. The DC voltage Then powers a DC to DC converter, which may be a step-down converter, which changes the DC voltage to a different level appropriate for use by the attached device. The DC to DC converter may also contain a transformer to provide desired safety isolation of the DC output from the AC input. An AC charger of the type just described always consumes power when connected to the AC power source, regardless of whether a target device, typically a portable device, is being charged or even connected thereto.

Energy saving chargers as previously developed will switch to a reduced power consumption state, or shut off completely and consume no power when not actively charging or powering a portable device. If a charger switches to a low power state, some energy continues to be unavoidably wasted in this low power consumption state. If a no-idle-power charger shuts off completely to save power, the charger cannot then power up by itself since it needs an external source of power to turn back on. Typically a manual switch is activated by a user to connect a power source to the no-idle-power charger to restart it. However, it is desirable that the no-idle-power charger is able to power up without manual intervention by the user.

For example, a no-idle-power charger will not maintain a full charge on a portable device that remains attached to the no-idle-power charger for long periods of time since the no-idle-power charger in its zero power state does not have the ability to restart automatically to recharge the portable device battery as the portable device batter drains over time. Also, the charger will not start up automatically if a portable device is plugged into the charger when the charger is powered down. Thus, a system, method and apparatus are desired to allow a powered down no-idle-power changer to power up automatically under certain conditions.

### SUMMARY

The problem of the prior art depowered charger being unable to turn itself on without a manual user intervention is addressed and solved as described below. Portable devices are typically battery powered and the power in the device battery can be used to restart a charger which is in a completely depowered state.

One way of charging the battery in a portable device is through the use of a cable with multiple conductors that are to be electrically connected between the charger and portable device when the portable device needs to be charged. Power then flows from the charger through the cable to the portable device to thus charge the battery in the portable device. In addition, portable device may be operated while the battery is charging. The inventors have discovered that this cable may be used to provide for power flow in the opposite direction, i.e., from the portable device battery back to the charger, when it is desired to start up the depowered charger and possibly also to shut down the charger.

The power flow from the portable device to the charger may be through the same cable or conductors used to charge the device battery or the power flow may be via other conductors. The portable device may initiate the signal or power flow to power up or power down the charger based on the battery charge level and/or the connect status with the charger. The portable device may also initiate the power flow based on a software application program operable on the power device.

In one exemplary non-limiting implementation of the present concept, the charger has a relay with an operating coil to which the portable device may connect electrically. The relay includes contacts which are operable to connect the charger to its power source to start up the charger and may also disconnect the charger form its power source. For example, when the portable device needs to be charged, it sends a signal or power flow to the relay coil which causes the relay contacts to close. The closed relay contacts thus connect the charger with its power source to power up the charger. The relay receiving the signal or power flow from the portable device may be a latching relay in which case the signal or power flow from the portable device may be a limited duration pulse with a duration long enough to change the state of the relay contacts to the closed position or open position. The relay can provide isolation where necessary between the signal from the portable device and the power source

In another exemplary, non-limiting implementation of the present concept, the charger has circuitry which receives a signal or power flow from the portable device and this circuitry engages the power source with the charger to turn the charger on and off. In the case where electrical isolation is required, optocouplers may be employed.

In yet another exemplary, non-limiting implementation of the present concept, the portable device uses a USB port for receiving charging power. The portable device sends signals or power flow over the USB connection from the portable device to the charger to control the power state of the charger. This may be considered a USB link and the charger may intelligently communicate with the portable device over this USB link or in its simplest form may just respond to simple power on and off signals from the portable device.

In yet still another exemplary, non-limiting implementation of the present concept, a software application is provided to be installed on a portable device to control the turn-on and turn-off of the charger. The software application could be provided with the charger for use on compatible devices such as smart cell phones and portable computers. The software application may allow the user more control over the charging function. The user may select a less than full charge level (i.e. 85%) at which the charger is shut off to protect the battery of the target device from the stress of a full charge thus extending the useful life of the battery. The software may allow the user to set a convenient time each day for the charger to begin the charging cycle or to finish the charging cycle for the portable device. The software may allow the charging rate to be reduced for a longer charge cycle which also reduces stress on the battery for a longer battery life. The software can monitor the decline in battery capacity over time to warn of a weakening battery. In some forms of the present concept the software communicates with the power device through a USB cable connection. In some forms the communication is accomplished with a wireless connection to the power device. This connection may be in the form of a Bluetooth wireless connection. In another form the portable device may control the on and off state of the power device by sending a wireless signal to the smart grid to enable and disable power to the corresponding outlet.

In another form of the present concept, the software application may be installed within the power device. The adjustment settings may be in the form of a LCD display located on the power device housing. The display may have buttons to set desired charging options by the user. The display may be connected to a microprocessor to control an on and off state of the power device.

### BRIEF DESCRIPTION OF THE DRAWINGS

The present concept may be more fully understood upon reading the following detailed description taken in conjunction with the drawings. The drawings should be understood as exemplary and non-limiting in nature. In the drawings:

FIG. 1 is a circuit diagram of a conventional AC charger;

FIG. 2 is a circuit diagram of a conventional AC charger which must be manually;

FIG. 3 is a circuit diagram of a charger according to one non-limiting embodiment;

FIG. 4 is a circuit diagram of a charger according to another non-limiting embodiment;

FIG. 5 is a circuit diagram of a charger according to another non-limiting embodiment;

FIG. 6 is a circuit diagram of a charger according to another non-limiting embodiment;

FIG. 7 is a circuit diagram of a charger according to another non-limiting embodiment;

FIG. 8 is a circuit diagram of a non-limiting embodiment; and

FIG. 9 is a circuit diagram of a non-limiting embodiment.

### DETAILED DESCRIPTION

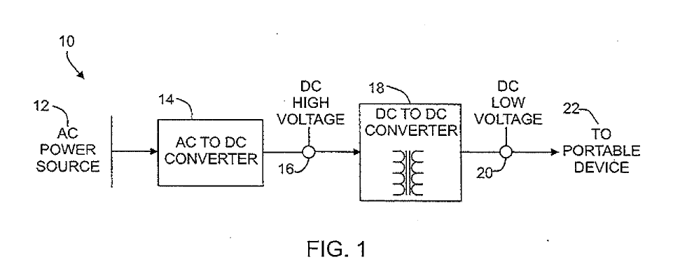

FIG. 1 illustrates a conventional AC charger 10 in which power from an external AC power source 12 flows through an AC to DC converter 14 to convert the AC input voltage to a DC output voltage. The DC output voltage may be referred to as a “high” voltage 16 which is connected as the input to a DC to DC converter 18, which changes the high DC voltage to a different level, e.g., a low voltage 20 appropriate for use by a suitable portable device 22. Thus in the illustrated example, the DC to DC converter 18 may be thought of as a step-down voltage converter. Depending upon the requirements of the portable device 22, the DC to DC converter may also contain a transformer to provide required safety isolation between the DC output of the converter 18 and the AC input to the converter 14. This AC charger 10 would always consume power when connected to the AC power source, regardless of whether a target device is being charged,or even connected thereto.

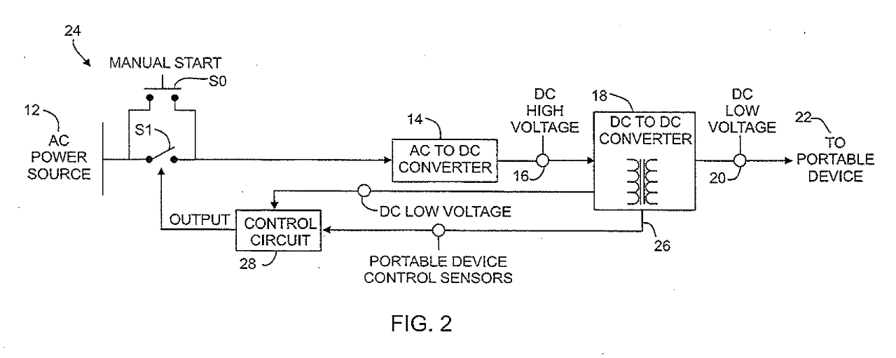

An energy saving battery powered portable device charger, such as that shown in FIG. 2, has been developed to shut off and consume no power when not actively charging a device battery. The charger 24 of FIG. 2 includes a control circuit that is powered from the same high power DC to DC converter 18 that is used to charge the target device 22 and monitors the power drawn by the portable device. The low voltage output 20 from the converter 18 is provided not only to the target device 22 but also provided on lead 26 to a control circuit 28. The output from the control circuit goes to a switch S1 which is positioned between the AC power source 12 and the AC to DC converter 14. The charger of FIG. 2 will not maintain a charge on a portable device that remains attached to the charger for long periods of time since the charger in its zero power state does not have the ability to restart automatically.

Thus, while it not optimal for a charger to always be drawing unnecessary power when plugged in, it is also not always optimal for a charger to shut off completely either, because in such cases the changer cannot monitor for certain conditions. For example, certain occasions may arise when the device plugged into the charger was charged once already but has remained plugged into the charger for an extended time and needs a further charge or “top off.” Another condition that is difficult for a completely powered down charger to detect is sensing that the device has just been plugged into the charger. In the charger of FIG. 2, a manual switch S0, placed in parallel with switch S1, must be closed if switch S1 is open such that power from the AC source is connected to the AC to DC converter 14. The conditions mentioned above are instances where it would be advantageous to keep a device charger powered, but at a very low current draw, to be able to monitor conditions requiring the charger to perform one or more responsive operations, such as restarting.

As noted above, various non-limiting embodiments of the present concept are described and these involve circuitry which uniquely minimizes idle power draw from a charger or power adapter while not supplying power to a portable device. While keeping a low-power circuit (e.g. on the order of micro watts) powered up all the time for these purposes would not be a true zero waste design, the convenience of such a circuit may outweigh the very small power required to maintain a low-power circuit in an on-state at all times.

In one such non-limiting embodiment, the charger includes an efficient, low-power DC to DC converter supply circuit that draws power from the AC or DC power source for the charger. This DC to DC converter would maintain power on a control circuit such that the control circuit could control the operation of the charger and restart the charger when desired. The DC to DC converter supply may supply energy to a storage device such as a battery, a capacitor or a super capacitor, which in turn powers the control circuit. If a large storage device is used, the time that the low-power DC to DC converter is activated and supplying power to the storage device may be a very short, periodic duration, followed by a very long off period during which no power is drawn from the AC power source. The use of this low-power DC to DC converter would have the advantage of wasting much less energy to charge the energy storage device for the control circuit than powering up from a shut-down state the charger's high power DC to DC converter that is used to supply charging power to the target device.

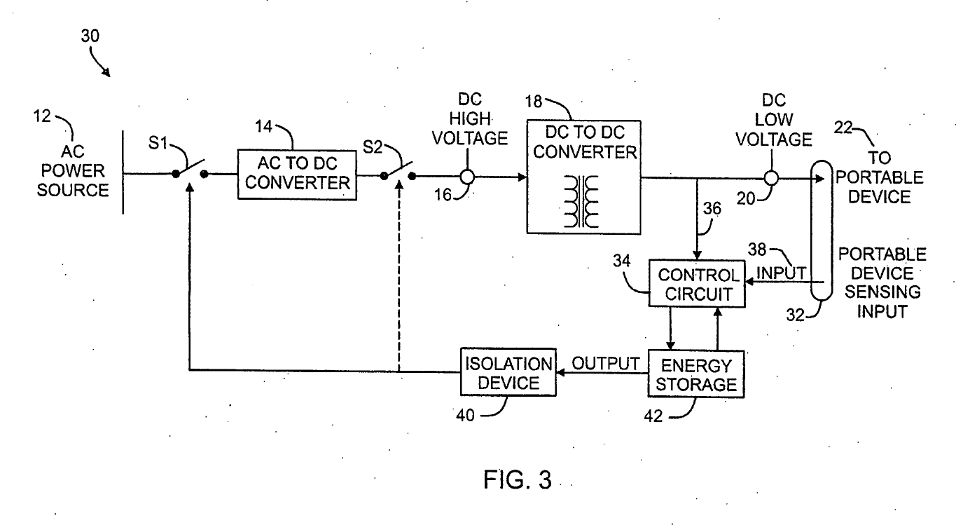

FIG. 3 illustrates a non-limiting embodiment of an improved charging circuit 30. The illustrated embodiment is operable to receive power from an AC or DC power source. With an AC source 12, an AC to DC converter 14 is included to convert the incoming power to a DC voltage level 16. It should be appreciated that in an embodiment with a DC source, such as a car charger for a mobile telephone, the AC to DC converter may be omitted. A DC to DC converter 18 converts a typically higher DC voltage level 16 to a DC output voltage level 20 which is suitable to power the attached device 22 through a standard cable and/or connector identified as 32 in FIG. 3. A control circuit 34 receives DC output voltage power when the DC to DC converter is operational such as via lead 36. These signals may be a constant voltage or a varying voltage or a stream of pulses from the secondary winding of the transformer within the DC to DC converter 18, or otherwise proportional to the charging power supplied to, and thus the power consumed by, the portable device 22. The control circuit 34 may also receive a signal via lead 32 indicating that the portable device has been attached to the charger DC output cable connector and this attachment signal may come from a mechanical switch that is physically engaged when the DC output connector is plugged into the target device. The attachment signal may also be an electrical circuit connection which occurs on one or more conductors connecting the charger to the portable device. Individually and collectively these are identified as input 38 to the control circuitry 34.

When the control circuit 34 determines that the portable device is no longer attached to the charger or no longer requires charging or power to operate, based on the current sensing input or the portable device sensing input, the control circuit 34 sends an output signal to open switch S1 or S2 which cuts the source power to the charger to save energy. Switches S1 and S2 are connected in series with the AC to DC converter 14 therebetween. Thus switch S1, when closed, permits an input from the AC power source to flow to the AC to DC converter 14 and switch S2, when closed, permits the output from the converter 14 to flow to the DC to DC converter 18. If the charger is powered by a high voltage AC source, the signal from the control circuitry 34 to switches S1 or S2 must pass through an isolation device 40, which can be an optocoupler, an isolating relay coil or other such device known in the art.

Under normal operation (i.e. while charging a target device) the DC to DC converter 18 supplies power to the control circuit, however, the control circuit may require another source of power to remain powered and operating in a reduced power mode when the DC to DC converter is powered off. Accordingly, the control circuit is connected to an energy storage device 42, such as a capacitor, super capacitor or battery, and stores energy in that storage device 42 when the DC to DC converter is powered on. This stored energy is then subsequently used to power the control circuit during periods in which the charger is disconnected from the power source, such as when it is not powering or charging a portable device. The control circuit 34 monitors the charge level of the energy storage device 42 and maintains a full charge while the charger is powered. If the charger is powered off, the control circuit may power up the charger for a period of time sufficient to allow the DC to DC converter to recharge the energy storage device 42, if the charge level falls below a desired minimum level. The control circuit may then power down the charger again.

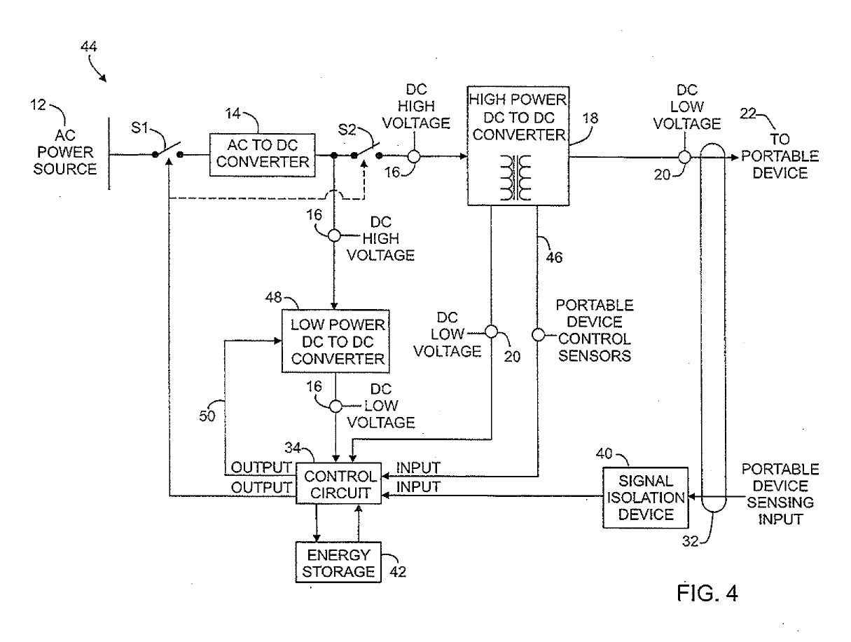

FIG. 4 illustrates another variation of a charging circuit 44 which receives its power from an AC or DC power source. With an AC source 12, an AC to DC converter 14 is included to convert the incoming power to relatively higher DC voltage level 16. Again, it should be appreciated that in an embodiment with a DC source, such as a car charger, the AC to DC converter may be omitted. A high power DC to DC converter 18 converts this DC voltage level to a DC output voltage level 20 which is suitable to power the target device 22 through a cable and/or connector 32. The high power DC to DC converter may also provide power to a control circuit 34 when the high power DC to DC converter is powered. The high power DC to DC converter may also supply signals to the control circuit which are correlated to the power consumed by the attached portable device such as on lead 46. These signals may be a varying voltage or a stream of pulses from switch mode circuitry controlling the transformer within the high power DC to DC converter. The control circuit may also receive a signal indicating that the portable device has been attached to the charger DC output cable connector 32. As described above, this signal may require an isolation device 40 for safety if a high voltage AC power source is used to power the charging circuit. As previously noted, the signal isolation device may be one commonly known in the art. The attachment signal may be received from a mechanical switch that is physically engaged when the DC output connector is plugged into the portable device. The attachment signal may also be from an electrical circuit connection received from one or more conductors connecting the charger to the portable device. However, the portable device sensing input may not have any power associated with it, and it may be an unpowered mechanical electrical contact closure or unpowered circuit connection between two conductors on the portable device side of the signal isolation device.

To address this unpowered signal input from the portable device 22, the signal isolation device 40 can be an isolation transformer controlled by the control circuitry in a unique manner. The isolation transformer has two windings that are electrically isolated from each other and may have either an air core or a core made of ferromagnetic or ferromagnetic material which magnetically couples the two windings. One isolation transformer winding is electrically connected to the control circuit and the other winding is connected to the unpowered circuit connection or mechanical switch. When the mechanical switch or circuit connection is engaged, it will short the isolation transformer winding to which it is attached. This short circuit will change the electrical properties of the transformer on the other winding attached to the control circuit. The control circuit can periodically generate a voltage or current pulse on the isolation transformer winding. The control circuit then monitors the voltage and or current response from the transformer winding following the generated pulse applied to the winding. The control circuit can distinguish between the second winding being shorted or open based on the winding response to the voltage or current pulse, thus transferring the status of the target device being attached to the charger across the isolation device to the control circuit.

When the control circuit 34 determines that the target device 22 is no longer attached to the charger or no longer requires charging or power to operate, based on the current sensing input or the target device sensing input, the control circuit sends a signal to turn off switch S2, which is located between the AC to DC converter 14 and the DC to DC converter 18 and this cuts the power to (i.e., disconnects power from) the high power DC to DC converter 18 to save energy. Since the high power DC to DC converter 18 also supplies power to the control circuit, the control circuit requires another source of energy to remain powered and operate in a reduced power mode with the high power DC to DC converter powered off. Accordingly, a second, low power DC to DC converter 48 is provided and receives power as at 16 from the output of the AC to DC converter upstream of switch S2, as well as a signal from the control circuit 34 via lead 50. Thus the DC to DC converter 48 is controlled by the control circuit to periodically send pulses of energy to be stored in an energy storage device 42, such as a capacitor, super capacitor or battery, and used to power the control circuit. This low power DC to DC converter 48 is much more efficient at providing the very small quantity of power required by the control circuit while in a reduced power mode than the alternative of periodically powering up the high power DC to DC converter 18. This high efficiency allows the control circuit to consume extremely low power when not powering or charging a portable device 22. As a non-limiting example this low power DC to DC converter 48, which may be considered an auxiliary converter, could be a conventional capacitive charge pump converter and as another non-limiting example could be a “buck” style inductive switching supply, both of which are well known in the art.

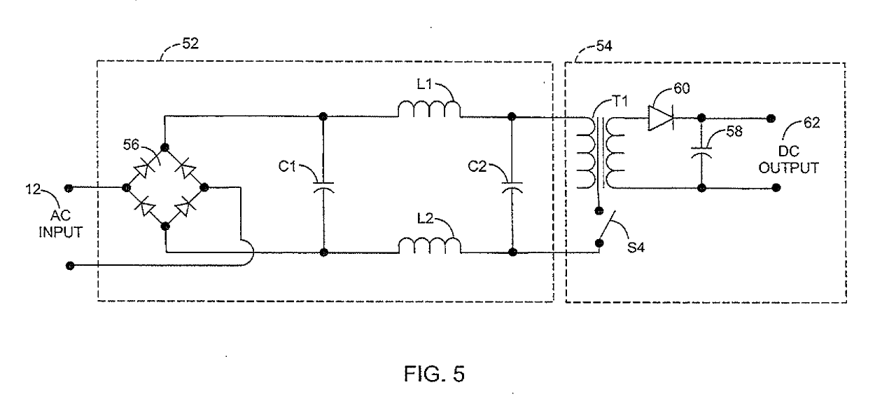

FIG. 5 illustrates a charger according to another non-limiting embodiment including a charging circuit having an AC to DC converter 52 supplying an input to a DC to DC converter 54. The AC to DC converter itself would be conventional having inputs connected to a rectifying diode bridge 56, the outputs of which go through coils or inductors L1 and L2 to the input side of a transformer T1. High voltage DC buss capacitors C1 and C2 are provided in parallel between the coils L1 and L2. A switch S4 is provided in series with one side of the input coil to transformer T1. The output coil from the transformer T1 is connected through a diode 60 and across a capacitor 58 to provide the DC output 62.

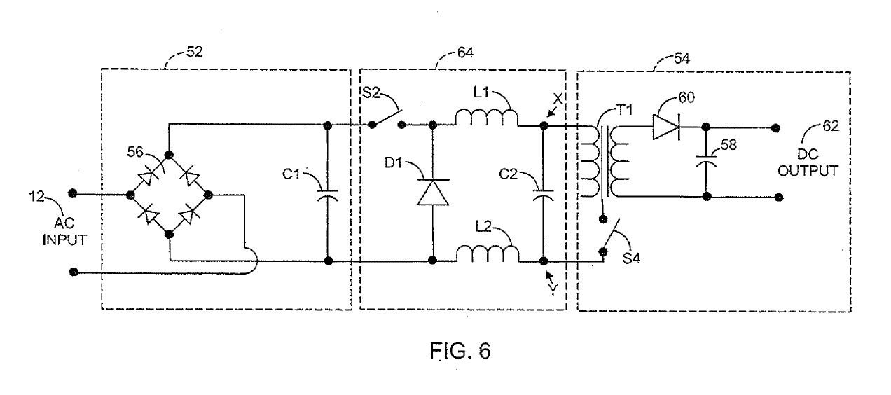

FIG. 6 illustrates another charging circuit in accordance with another non-limiting embodiment of the present concept. Many of the components in FIG. 6 are arranged in the same manner as in FIG. 5 and thus the description of those components will not be repeated. The circuit in FIG. 6 includes a “buck” style DC to DC converter 64 positioned between an AC to DC converter 52 and a DC to DC converter 54. This buck style, low power, DC to DC converter may use some of the components in the charger design of FIG. 5 to reduce cost, component count and circuit size. In particular, the buck style converter in FIG. 6 may use the input line filter inductors L1 and L2 and the high voltage DC buss capacitor C2 already being used. A switch S2 placed in series between the converter 52 and the converter 64 may be a solid state switch, such as a MOSFET, and when S2 is off, or open, the charger circuit is shut down, since the voltage on capacitor C2 across the converter 64, (between point X and point Y) supplying the input coil of transformer T1 and switch S4, will decrease to zero. If switch S2 closes periodically for short durations or pulses, this will supply charge to capacitor C2. By coordinating pulsed switching of switch S2, the voltage across capacitor C2 (between point X and Y) can be raised to a low DC level (e.g. below 12 V) that is much below the relatively higher DC voltage level needed to charge a target device. This low voltage is too low to power the high power DC to DC converter circuitry 54, but high enough to power the control circuitry. In this embodiment a diode D1 is placed in parallel with capacitor C2 on opposite sides of the inductors L1 and L2.

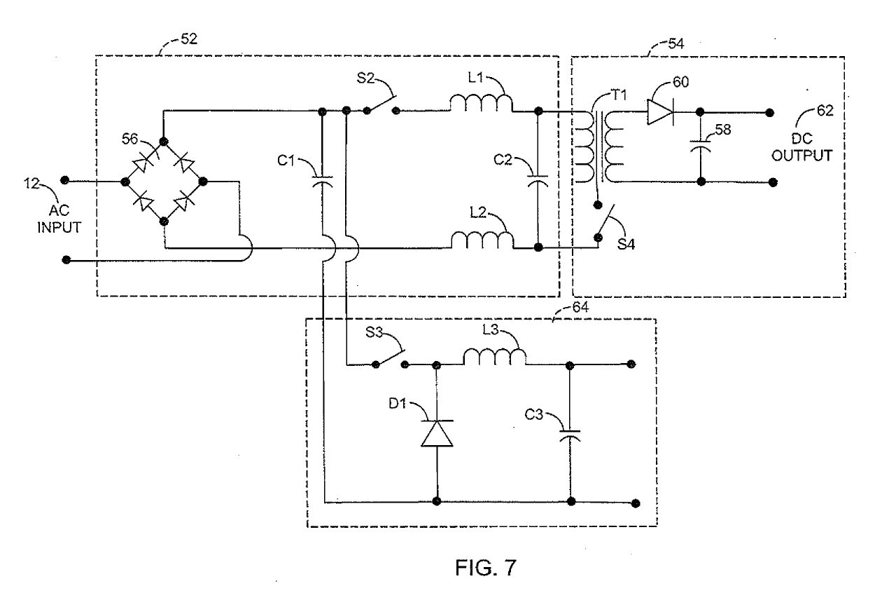

FIG. 7 illustrates another charging circuit in accordance with an embodiment of the present concept. Again, many of the circuit components in FIG. 7 are the same as in FIGS. 5 and 6 and therefore the details will not be repeated.

FIG. 7 includes the AC to DC converter 52 and the DC to DC converter 54. In addition, a circuit 64 is provided which takes its input from across the AC to DC converter 52 with one input taken upstream of switch S2 from one side of capacitor C1 and the other input taken from the opposite side of capacitor C1. Capacitor C1 is connected across the output of the rectifying diode bridge 56 as in FIGS. 5 and 6. The signal from the AC to DC converter taken from the side of the capacitor C1 upstream of switch S2 is fed into one side of switch S3 and the other side of switch S3 is connected to one side of a diode D1 and to one side of inductor or coil L3. The signal from the opposite side of capacitor C1 of converter 52 is connected to the opposite side of diode D1 and to one side of capacitor C3. The output from coil L3 is connected to the other side of capacitor C3. As above all the switches may be solid state switches such as MOSFETs. When switch S2 opens, the power to the transformer T1 and the switch S4 is shut down. Switch S3 together with diode D1, inductance L3, and capacitor C3 together comprise a low-power, buck mode DC to DC converter 64 which powers the control circuitry. Switches S2 in FIG. 6 and S2 and S3 in FIG. 7 can be controlled by the control circuit, which may include a microcontroller.

In various embodiments, energy harvesting may be used. For example, a solar or photovoltaic cell can be added to the charger circuit to supplement and/or replace the power provided by (e.g. stored in) the low-power DC to DC converter. In another embodiment, an ambient RF signal present in the atmosphere may be collected and converted to a power source to supplement and or replace the low power DC to DC converter. In still another embodiment, a thermal gradient or thermal change may be converted to a power source to supplement and or replace the low power DC to DC converter.

If the target device remains plugged into the charger after the charger is automatically powered down (i.e. once the charge is complete), the target device battery may discharge over a period of time. It is desirable that the charger has the ability to power itself up at a determined point in time time interval, or charge state of the portable device battery, to recharge the target device battery. In the above described circuits, after completing the charge of a portable device battery and the charger is powered down, the charger may maintain a control circuit powered at an ultra-low power level. Based on various inputs, the control circuit may then determine when to restart the charger to further charge the portable device battery.

The charger may be designed to limit the power provided to the target device battery to thereby reduce the stress on the battery from the repetitive, periodic recharge cycles. A target battery powered device may call for full power when initiating a battery charge and then may taper the power to a lower level once the state of charge is determined. For example, the battery may call for 1 A of current for the first 5 minutes and then gradually or rapidly reduce the current to a lower value as time progresses and as the current state of the battery charge becomes known by the battery charge controller in the target device. If the battery is close to full charge, this 1 A of current for the first 5 minutes may be stressful to the battery and can reduce the battery's life, especially if it occurs in a repetitive, periodic manner. To avoid this battery stress, various embodiments of the charger circuits or control circuits described herein may limit the initial current provided to the portable device to a lower value such as, for example, 0.5 A or 0.25 A instead of 1 A. The limit may be imposed when the portable device remains plugged into the charger and the charger has gone through at least one full charge cycle. Follow on periodic charger cycles under this condition will likely be top-off charges to a battery that is almost fully charged, so the limited charging current provides an advantage of less battery stress and wear.

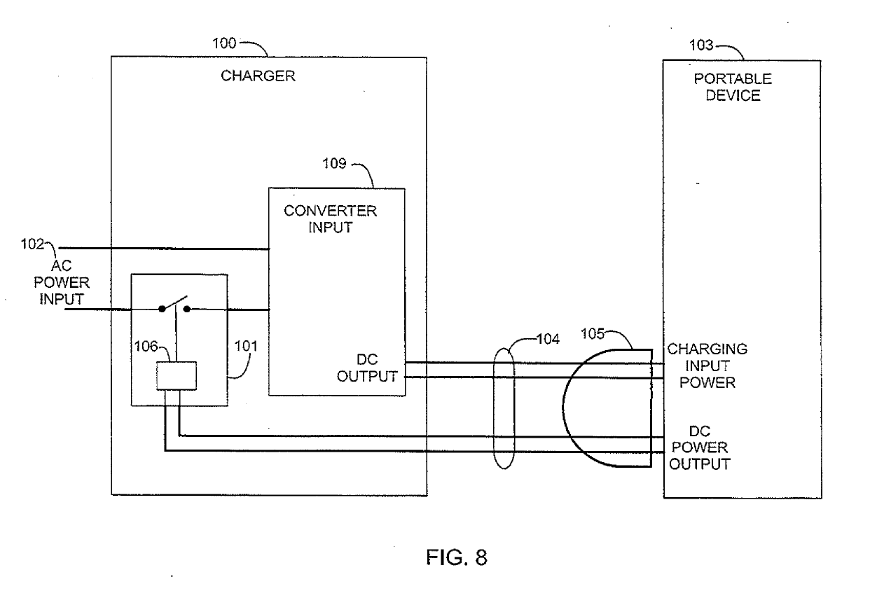

Reference should now be had to FIG. 8 in which a charger 100 is connected to charge a portable battery powered device 103. The connection between the charger 100 and the portable device 103 may be a multi-wire cable 104 and an electrical connector 105. The charger may include a solid state or electromechanical switch 101 having an operating coil or control circuit 106. Switch 101 functions to operably connect or disconnect the power source 102 to a converter 109, which has the desired DC voltage output, to power the charger on or off. When the battery in the portable device 103 is to be charged, the portable device sends a signal via a power output connection of the portable device through connector 105 and cable 104 to the charging circuit 100. This signal is of sufficient strength to close the switch such that power flows from the power input 102 to the converter 109 and out via cable 104 and through connector 105 to provide appropriate DC power to charge the battery in the device 103. The switch generally identified as 101 may be a latching relay in which case the signal or power flow may be a limited duration pulse long enough to change the state of 101 between closed and open positions and may provide electrical isolation where necessary.

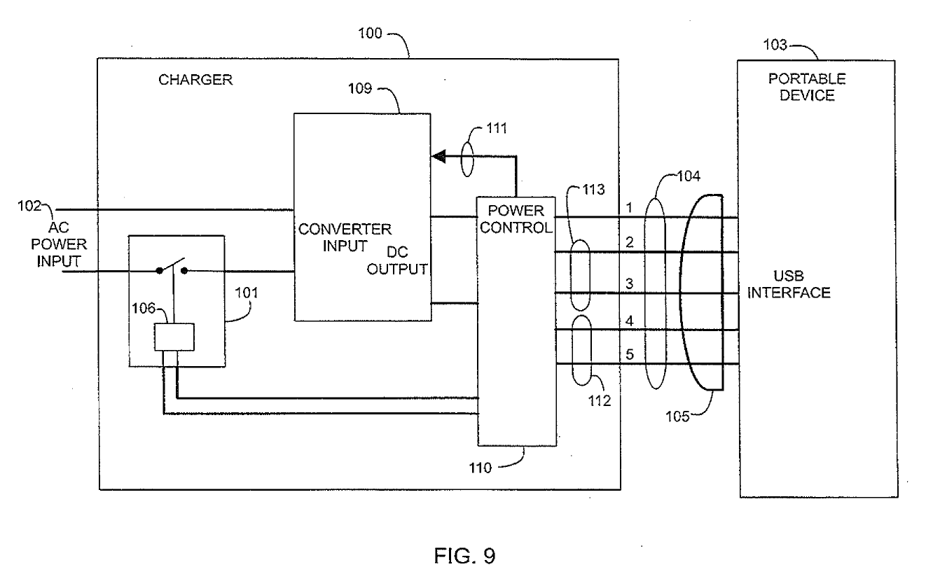

FIG. 9 illustrates yet another non-limiting embodiment of the present concept in which input power 102 is again provided to a switch 101 and a converter 109 to ultimately charge the battery of a portable device 103. In the illustration of FIG. 9, the connector 105 may be a conventional USB interface plug which connects to the USB interface typically supplied with battery powered portable devices. The USB plug may provide for multiple leads 104 (five being illustrated in FIG. 9). When the unpowered connector 105 is plugged into, or engages, the portable device 103, a low voltage signal is sent from the portable device 103 through plug 105 and cable 104 to a power control circuit 110. In response to this signal, circuit 110 sends signals to close switch 101 so that electrical power from the AC supply or power input 102 is provided to the charger 100.

As an example, with power control circuit 110 unpowered, an electrical connection 112 is made on leads or connectors 4 and 5 in the USB cable when the USB interface cable is plugged into the device to provide the low level signal to the control circuit 110. A separate signal 113 on leads or connectors 2 and 3 in the USB cable may indicate that the device 103 is not ready to receive power, e.g., that the battery in device 103 is fully charged. This may be controlled in the charger 100 via an output signal 111 from the control 110 to the converter 109.

When charger 100 is powered on, control circuit 110 disconnects the signal on leads 4 and 5 (connection 112) and the connection on USB leads 2 and 3. It should be appreciated that the references to the connectors 1 through 5 in the USB cable refer to corresponding pins within the USB interface.

To shut off the charger when the portable device no longer needs power from the charger, the portable device may communicate with the charger over the USB link or may just respond to simple power on and off signals from the portable device.

While a USB port operation is discussed above, other port configurations may be used to accomplish the transmission of power from the portable device to start up the charger. In another implementation, a software application may be downloaded/installed on a portable device to control the turn-on and times of the charger. Such a software application may allow the user more control over the charging function and the charger. The user may select a less than full charge level (i.e. 85%) at which the charger is shut off to protect the battery from the accelerated stress of a full charge and to extend the life of the battery. In addition software would allow the user to turn the charger back on by selecting a battery low charge level at which the charger turns back on to top off the battery charge. For instance, after the charging and the charger has been powered off, the charger may be powered back on to top off the portable device battery once the battery level reaches a user selectable “remaining battery life” level of 20, 40, 60, 80, or 95%. By selecting a top-off level of 40 to 60%, the life of the battery will be extended, while selecting 95% the user will be provided with the most battery use time for the portable device at the expense of battery life.

Software as just described allows the user to set a convenient time for the charger to begin the charging cycle or the software may calculate a charging cycle start time based on a desired charging finish time for the portable device (i.e. just before leaving in the morning). The software may allow the charging rate to be reduced at times (i.e. overnight charging) for a longer and more gentle charge cycle which reduces stress on the battery for a longer battery life. The software can monitor the decline in battery capacity over time to warn of a weakening battery that needs to be replaced.

As portable devices such as smart cell phones and tablet computers become more prevalent, a growing need exists to provide backup protection for the data stored on such devices. Currently, data backups for such devices can be accomplished by linking the device to a computer and storing the backup data on a computer, or by linking the device to a special purpose server containing a backup device which stores the data on the backup device, or by storing the backup data wirelessly via a cellular network or via an Internet connection to a remote server operated by a cellular carrier or other service provider. Storing backups on a computer or server-contained backup device is usually inconvenient as it requires extra time taken outside a user's typical routine to accomplish. Also a computer may not be available or convenient. Remote server backup provided by a service provider is convenient but can be costly over time and may suffer from data security breaches.

Thus, the need exists for a simple, secure way to backup data from portable devices. The memory backup function as just described may be integrated into a charger and controlled by application software installed in the portable device being charged by the charger.

Most portable devices such as cell phones and tablet computers use charging ports that are also used as data ports. As an example, as noted above, most cell phones use a USB standard port to both charge the cell phone battery and to transfer data. When a cell phone (as an example) is plugged into its charger, the charger can charge the cell phone battery while at the same time it can back up the cell phone data to a special circuit in the charger using a software application program installed on and controlled by the cell phone. Since charging is a common and repeated routine for all cell phone users, backing up data from the cell phone while charging is a most convenient backup method for the user. Charging usually takes a few hours and is typically done at night which is also convenient from a backup prospective. The charger includes built-in control circuitry, memory circuitry, and communication circuitry known in the art to provide the backup functionality.

Finally, it should be appreciated that the signal from the device to the charger circuit may be a wireless signal in lien of a signal via a USB port as previously described.

The foregoing is a complete description of the concept although may other changes and modifications may be made by those of skill in the art having the benefit of reading the above description. Therefore, the foregoing should not be construed as a limitation on any aspect of the concept.

1. In a power charger circuit converting input energy to DC output energy for charging the battery of a portable device, said input energy adapted to flow in a first direction to provide said output energy to said portable device, the improvement comprising:
said power charging circuit including at least one switch having an open state and a closed state, said open state to interrupt the flow of said input energy in said first direction; and
said power charging circuit adapted to provide energy flow in a second direction opposite to said first direction.

2. The invention as defined in claim 1, wherein the energy flow in said second direction moves said at least one switch from a closed state to an open state.

3. The invention as defined in claim 1, wherein said power charging circuit switch is in said closed state prior to said power charging circuit being connected to a portable device.

4. The invention as defined in claim 1, further comprising power flow control circuitry operable to direct an initial supply of power from the portable device to the power charger circuit for causing the at least one switch to change to the closed state such that the power charging circuit is adapted to charge said portable device.

5. The invention as defined in claim 1, wherein the power to move said at least one switch to said closed state is received by a cable assembly from said portable device.

6. A power device for supplying electrical power to a portable electronic device with an on-board battery, comprising;
an input portion for receiving input electrical power;
a converter portion including converting circuitry for converting the input electrical power to output electrical power;
switch circuitry for controlling an on state and an off state for the power device; and
operational components within the electronic device for determining charging levels for the on-board battery;
wherein the operational components within the electrical device send signals to the switch circuitry for connecting and disconnecting electrical power to the electrical device.

7. The invention as defined in claim 6, wherein the operational components monitor the charge level of an on-board of an on-board battery.

8. The invention as defined in claim 6, wherein the operational components send a signal through at least one control line.

9. The invention as defined in claim 6, wherein the switch circuitry is a microprocessor.

10. The invention as defined in claim 6, wherein the switch circuitry receives the instruction from and delivers power to the on-board battery for charging.

11. The invention as defined in claim 6, wherein the switch circuitry receives the instruction from and ceases delivering power to the on-board battery.

12. The invention as defined in claim 6, wherein the electronic device is a laptop computer.

13. The invention as defined in claim 2, wherein the output energy is adapted to be provided to a device having a rechargeable battery and wherein the energy flow in said second direction is in response to a signal received from said device.

14. The invention as defined in claim 3, wherein the output energy is provided to said device via a USB link.

15. The invention as defined in claim 3, wherein said signal from said device is provided to via a USB link.

16. A power device for supplying power to an electronic device, the power device comprising:
an input for receiving electrical input power from a source, the input power having an AC input voltage;
an output for delivering electrical output power to the electronic device, the output power having a DC output voltage;
prongs for electrical communication with a receptacle of a power outlet; and
power circuitry for converting the input voltage to the output voltage and transformer control circuitry; and
a solid state switch coupled between the input and the transformer; and
control circuitry for causing the solid state switch to close in response to a remote electrical connection established between two terminals to change the power circuitry to an “on” state and for causing the solid state switch to open to change the power circuitry to the “off” state.

17. The invention as defined in claim 16, wherein the solid state switch connects proximate to one of the prongs for disconnecting the input power before the power-consuming components.

18. The invention as defined in claim 16, wherein the solid state switch, the power circuitry and transformer control circuitry are incorporated into a single integrated circuit.

19. A power device for supplying power to an electronic device the power device comprising:
a first portion for receiving electrical input power from a power source, the electrical input power having an input voltage;
a second portion for delivering electrical output power to the electronic device, the output power having an output voltage;
a transformer and load sensing portion operable to sense one or more pulses and determine the power or load being drawn from the power device by the electronic device;
power circuits for converting the input voltage to the output voltage and for controlling the output voltage based, at least in part, upon feedback from the transformer;
switching circuitry for switching the power device between a fully powered state and a reduced power state;
wherein the switching circuitry automatically switches the power device to the reduced power state in response to a reduced power draw by the electronic device, the switching circuitry disconnecting power to the transformer when in the reduced power state and wherein the output voltage is substantially constant when power circuitry is in the fully powered state.

20. The power device of claim 19, wherein the power device in the reduced power state, the output voltage drops to zero.

21. The power device as recited in claim 19, wherein the load sensing portion is operable to sense a pulse width of one or more pulses from transformer control circuitry which controls power state of a transformer of a power device.

22. The power device as recited in claim 19, wherein the load sensing portion is operable to sense an amount of time between two or more pulses.

23. The power device as recited in claim 19, wherein the load sensing portion is operable to sense a magnitude of one or more pulses.

24. The power device of claim 19, wherein the load sensing device is incorporated within an integrated circuit.

25. The power device as recited in claim 19, wherein the switching circuitry comprises a microcontroller.

26. A power device for supplying power to an electronic device, the power device comprising:
an input for receiving electrical input power from a power source, the input power having an AC input voltage;
an output for delivering electrical output power to the electronic device, the output power having a DC output voltage;
power circuitry for converting the input voltage to the output voltage, the power circuitry including a transformer;
a load sensing portion to sense one or more pulses to measure current drawn from the power device by the electronic device, the load sensing portion having a predetermined threshold level;
switching circuitry for switching the power device between a fully powered state and a reduce power state, the switching circuitry electrically coupled to electrically connect or disconnect power to the transformer; and
wherein the switching circuitry disconnects the output power to the electronic device when power being drawn from the power device by the electronic device is at or below the predetermined threshold level.

27. The combination of claim 26, wherein the power device consumes a small portion of power in the reduced power state.

28. The combination of claim 27, wherein the power consumed in the reduced power state by the power device is on the order of microwatts.

29. The combination of claim 26, wherein the switching circuitry includes a solid state switch.

30. The combination of claim 26, wherein the switching circuitry intermittently powers on the DC output to monitor the load via the load sensing portion.

31. The combination of claim 30, wherein the switching circuitry periodically powers up the load sensing portion including the transformer to determine if the electronic device is attached or in need of charging.

32. The power device of claim 26, wherein the load sensing portion determines the power or load being drawn from the power device by the electronic device by measuring the size of the pulses.

33. The power device of claim 26, wherein the load sensing portion determines the power or load being drawn from the power device by the electronic device by measuring a frequency of the pulses.

34. The power device of claim 26, wherein the load sensing portion measures the pulses electrically on a winding of a transformer of the power device.

35. The power device of claim 34, wherein the load sensing portion measures the pulses across a capacitor within a circuit that connects to the winding of the transformer of the power device.

36. The power device of claim 26, wherein the load sensing portion measures the pulses from transformer control circuitry which controls a power state of the transformer of the power device.

37. The power device of claim 36, wherein the transformer control circuitry comprises switched mode power supply circuitry.

38. The power device of claim 36, wherein the transformer control circuitry comprises pulse-width modulation (PWM) circuitry.

39. The power device of claim 26 further comprising transformer control circuitry for controlling a power state of a transformer of the power device, wherein the transformer control circuitry and the load sensing portion are incorporated onto a single integrated circuit.

40. The power device of claim 26, wherein the DC output is shut off in the reduced power state.

41. A desktop charger for charging an electronic device, the desktop charger comprising:
a first portion for receiving electrical input power from a power source, the input having an input voltage;
a second portion for delivering electrical output power to the electronic device, the output power having an output voltage;
power circuitry for converting the input power voltage to output power voltage and for controlling the output power voltage based, at least in part, upon the feedback of the transformer;
switching circuitry operable to de-power at least a portion of the desktop charger; a transformer and a load sensing portion operable to sense one or more pulses and determine the power or load being drawn from the desk top charger by the electronic device.

42. The power device of claim 41, wherein the power device in the reduced power state, shuts off output power to the electronic device.

43. The power device as recited in claim 41, wherein the load sensing portion is operable to sense a pulse width of one or more pulses.

44. The power device as recited in claim 41, wherein the load sensing portion is operable to sense an amount of time between two or more pulses.

45. The power device as recited in claim 41, wherein the load sensing portion is operable to sense a magnitude of one or more pulses.

46. The power device of claim 41, wherein the load sensing device is incorporated within an integrated circuit.

47. The power device as recited in claim 41, wherein the switching circuitry comprises a microcontroller,

48. A desktop charger for charging an electronic device, the desktop charger comprising:
a first portion for receiving electrical input power from a power source, the input having an input voltage;
a second portion for delivering electrical output power to the electronic device, the output power having an output voltage;
power circuitry for converting the input power voltage to output power voltage;
switching circuitry operable to de-power at least a portion of the desktop charger; and
a load sensing portion operable to sense the power or load being drawn from the desktop charger by the electronic device wherein the output voltage is substantially constant when power circuitry is in a fully powered state.

49. The desktop charger as recited in claim 48, wherein the second portion comprises the power circuitry, the switching circuitry and the load sensing circuitry.

50. The desktop charger as recited in claim 48, further comprising a switch assembly having a member movable to and between first and second positions, wherein the switch assembly causes the switching circuitry to de-power at least a portion of the desktop charger when in the first position.

51. The desktop charger as recited in claim 50, wherein the switch assembly causes the switching circuitry to reactivate the de-powered portion of the desktop charger when in the second position.

52. The desktop charger as recited in claim 48, further comprising a motion-sensing switch operable to sense movement of at least a portion of the desktop charger and to cause the switching circuitry to reactivate the de-powered portion of the desktop charger upon sensing motion.

53. The desktop charger as recited in claim 48, wherein the desktop charger is a cradle-type charger.

54. The desktop charger as recited in claim 48, wherein the load sensing device is operable to cause the switching circuitry to de-power at least a portion of the power device after determining that the load being drawn from the power device by the electronic device has been below a threshold level for a predetermined amount of time.

55. A power device for supplying power to an electronic device, the power device comprising:
a first portion for receiving electrical input power from a power source, the input having an input voltage;
a second portion for delivering electrical output power to the electronic device, the output power having an output voltage;
power circuitry for converting the input power voltage to the output power voltage; and
switching circuitry operable to disconnect the first portion from the power source, thereby preventing the first portion from receiving the input power wherein the output voltage is substantially constant when power circuitry is in a fully powered state.

56. The power device as recited in claim 55, wherein the power device draws substantially no power from the power source when the first portion is disconnected from the source.

57. The power device of claim 55 wherein the switching circuitry includes a latching relay that is coupled between the input and the transformer to electrically connect or disconnect power from the source.

58. The power device of claim 55 wherein the switching circuitry includes a solid state switch that is coupled between the input and the transformer to electrically connect or disconnect power from the power source.

59. The power device of claim 58 wherein the power consumed by the power device is on the order of microwatts.

60. The power device of claim 55 wherein the switching circuitry automatically disconnects the input power to switch the system to an off state.

61. The power device of claim 55 wherein the switching circuitry monitors power draw of the electrical device indicating an on state for the electronic device, and the switching circuitry disconnects the input power to switch the power device to an off state.

62. The power device of claim 55 further comprising: pulse monitoring circuitry operable to monitor pulses and drive the switch circuitry based thereon.

63. The power device of claim 62 further comprising a transformer, wherein the pulse monitoring circuitry is operable to monitor pulses from the transformer and drive the internal switching circuitry based thereon.

64. The power device of claim 66 wherein the transformer includes a primary winding and a secondary winding, and the pulse monitoring circuitry is operable to monitor pulses from the secondary winding and drive the internal switching circuitry based thereon.

65. The power device of claim 65 wherein the pulse monitoring circuitry and the switching circuitry comprises a microcontroller.

66. The power device of claim 65 wherein the power circuitry, the switching circuitry and the pulse monitoring circuitry are integrated into an integrated circuit.
